(19) United States
(12) Patent Application Publication
(10) Pub. No.: US 2024/0125172 A1
(43) Pub. Date: Apr. 18, 2024

(54) ADJUSTABLE BOTTOM RETAINER FOR NON-PULL CORD WINDOW BLIND AND NON-PULL CORD WINDOW BLIND

(71) Applicant: SHEEN WORLD TECHNOLOGY CORPORATION, TAICHUNG CITY (TW)

(72) Inventor: PO-YU CHEN, TAICHUNG CITY (TW)

(21) Appl. No.: 18/065,837

(22) Filed: Dec. 14, 2022

(30) Foreign Application Priority Data
Oct. 17, 2022 (TW) 111139295

(51) Int. Cl. E06B 9/382; E06B 9/303

(52) U.S. Cl. CPC E06B 9/382; E06B 9/303

(57) ABSTRACT

An adjustable bottom retainer used in coordination with a non-pull cord window blind includes a base, and first and second worm rods. The base is disposed in a bottom beam of the window blind and has a set of ladder cord inserting holes. The first worm rod is inserted in the base and has a rotation driving hole exposed on the bottom surface of the bottom beam, enabling a hand tool to be engaged with the rotation driving hole to drive the first worm rod. The second worm rod is inserted in the base, engaged with the first worm rod, and fastened to bottom ends of first and second longitudinal strings of a ladder cord. Therefore, rotating the first worm rod makes the second worm rod engaged therewith wind the first and second longitudinal strings, thereby adjusting the total length of the ladder cord.

### BACKGROUND OF THE INVENTION

### 1. Field of the Invention

The present invention relates to non-pull cord window blinds and more particularly, to an adjustable bottom retainer which can adjust the total length of a ladder cord.

### 2. Description of the Related Art

At present, the commercially common non-pull cord window blinds primarily use the torsion of metal springs to balance the weight of a bottom beam so that the window blind can be unfolded and folded, so as to improve away the safety concerns of the traditional pull cord window blind.

As to the non-pull cord window blind, the position of height of the window is quite important. If the position of the window is too low, the bottom beam is liable to be in contact with the ground when the window blind is unfolded. For solving the above-described problem, the user usually tries to adjust the unfolded length of the window blind, which means adjusting the total length of a lift cord of the window blind. However, during the adjustment, the force is liable to be applied not well, thereby accidentally folding the window blind. It often takes several repeated operations to successfully complete the positioning. Besides, if the total length of the lift cord of the window blind has been adjusted, a ladder cord of the window blind for adjusting the tilted angle of slats also needs corresponding adjustment, that also causes inconvenience in adjustment, thereby still imperfect in use.

### SUMMARY OF THE INVENTION

It is a primary objective of the present invention to provide an adjustable bottom retainer for a non-pull cord window blind, which is adapted for different usage environments to adjust the total length of the ladder cord, thereby increased in convenience in use.

To attain the above objective, the present invention provides an adjustable bottom retainer, which is connected with a ladder cord of a non-pull cord window blind. The aforementioned ladder cord has a first longitudinal string and a second longitudinal string, which are disposed in a spaced manner, and a plurality of latitudinal strings connected between the first longitudinal string and the second longitudinal string. The aforementioned adjustable bottom retainer includes a base, a first worm rod and a second worm rod. The base has a first ladder cord inserting hole and a second ladder cord inserting hole, which are arranged oppositely to each other. The first worm rod is rotatably inserted in the base. The first worm rod has a head portion, a first rod portion and a first worm tooth portion. The head portion has a rotation driving hole, enabling a constructor to engage a hand tool, such as a screwdriver, with the aforementioned rotation driving hole to drive the first worm rod to rotate. The bottom end of the first rod portion is connected with the head portion. The first worm tooth portion is provided on the outer circumferential surface of the first rod portion. The second worm rod is rotatably inserted in the base. The axial direction of the second worm rod is perpendicular to the axial direction of the first worm rod. The second worm rod has a second rod portion and a second worm tooth portion. The bottom ends of the first longitudinal string and the second longitudinal string of the ladder cord are fastened to the second rod portion. The second worm tooth portion is provided on the outer circumferential surface of the second rod portion and engaged with the first worm tooth portion of the first worm rod.

It can be known from the above description that when the first worm rod is driven by the aforementioned hand tool to rotate, the second worm rod is driven by the first worm rod to rotate and roll up the bottom ends of the first longitudinal string and the second longitudinal string of the ladder cord during the rotation. Because the top end of the ladder cord is fastened to a cord rolling device to be kept unmoved, the constructor can adjust the total length of the ladder cord by the adjustable bottom retainer.

Preferably, the second worm rod further has a protruding annular portion. The protruding annular portion is provided on the outer circumferential surface of the second rod portion, and the bottom ends of the first longitudinal string and the second longitudinal string of the ladder cord are fastened to the second rod portion through the aforementioned protruding annular portion.

Preferably, the second worm rod further has a first through hole and a second through hole, which radially penetrate through the protruding annular portion and the second rod portion. The bottom end of the first longitudinal string of the ladder cord is inserted and fastened in the first through hole. The bottom end of the second longitudinal string of the ladder cord is inserted and fastened in the second through hole.

Preferably, the adjustable bottom retainer further includes two latching members combined with the bottom ends of the first longitudinal string and the second longitudinal string respectively. The two latching members are sized larger than the bore diameters of the first through hole and the second through hole respectively.

Preferably, the base has an open trough opened downward and communicating with the first through hole. The protruding annular portion of the second worm rod is located in the open trough.

Preferably, the rotation driving hole is cross-shaped for the convenience of being engaged with a hand tool such as a cross screwdriver.

The present invention additionally provides a non-pull cord window blind which includes a ladder cord, a bottom beam, an adjustable bottom retainer as described above, and a buckle member. The aforementioned ladder cord includes a first longitudinal string, a second longitudinal string, and a plurality of latitudinal strings connected between the first longitudinal string and the second longitudinal string. The aforementioned bottom beam has a first via and a second via, which are arranged oppositely to each other. The first ladder cord inserting hole and the second ladder cord inserting hole of the above-described adjustable bottom retainer correspond to the first via and the second via respectively. The bottom end of the first longitudinal string passes through the first via and the first ladder cord inserting hole in sequence to be fastened to the second rod portion. The bottom end of the second longitudinal string passes through the second via and the second ladder cord inserting hole in sequence to be fastened to the second rod portion. The aforementioned buckle member is buckled on the exterior of the bottom beam to make the first longitudinal string and the second longitudinal string pressed between the buckle member and the bottom beam.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a top perspective view of an adjustable bottom retainer of the present invention.

FIG. 2 is a bottom perspective view of the adjustable bottom retainer of the present invention.

FIG. 3 is an exploded perspective view of the adjustable bottom retainer of the present invention.

FIG. 4 is a perspective view showing a bottom beam wherein the adjustable bottom retainer of the present invention is installed.

FIG. 5A is a perspective view of the adjustable bottom retainer of the present invention and a ladder cord used in coordination therewith, wherein a base is shown in a partially cut off manner.

FIG. 5B is similar to FIG. 5A, primarily showing a condition that the bottom end of the ladder cord is rolled up by a second worm rod.

FIG. 6 is a sectional view showing the usage of the adjustable bottom retainer of the present invention in coordination with the bottom beam.

FIG. 7 is an exploded perspective view of FIG. 4.

### DETAILED DESCRIPTION OF THE INVENTION

First of all, it is to be mentioned that throughout this specification, including the following embodiment and claims, the directional terms are all based on the direction shown in the figures. Besides, same reference numerals used in the following embodiment and the appendix drawings designate same or similar elements or the structural features thereof.

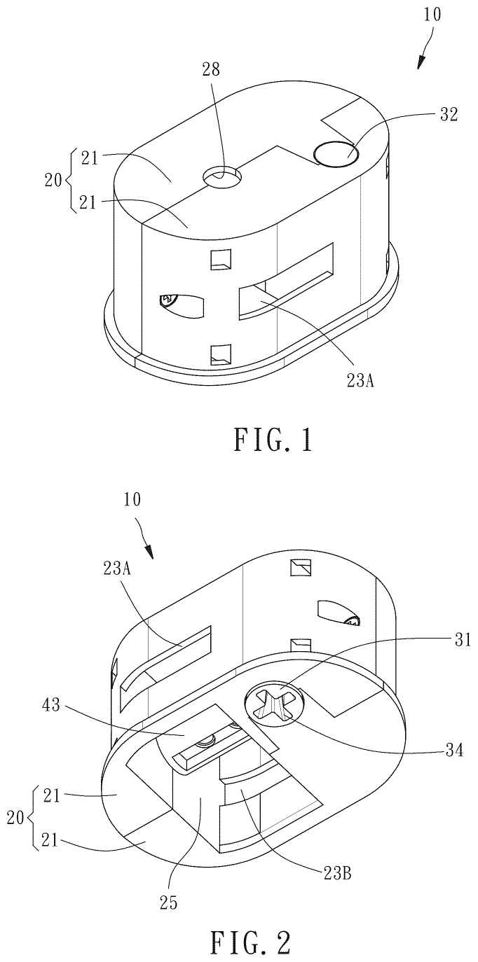

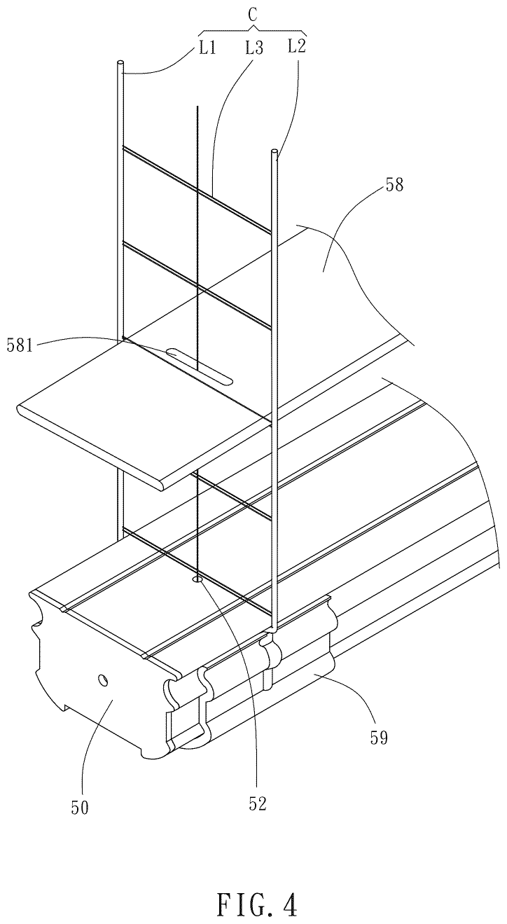

Referring to FIG. 1 to FIG. 4, an adjustable bottom retainer 10 of the present invention is adapted to be connected with a ladder cord C of a non-pull cord window blind 1. The ladder cord C has a first longitudinal string L1 and a second longitudinal string L2, which are disposed in a spaced manner, and a plurality of latitudinal strings L3 connected between the aforementioned first longitudinal string L1 and second longitudinal string L2. The first longitudinal string L1 and the second longitudinal string L2 extend vertically with respect to a bottom beam 50. The latitudinal strings L3 extend horizontally with respect to the bottom beam 50. A plurality of slats 58 are supported by the latitudinal strings L3 one to one. Only one slat 58 is shown in FIG. 4, and the rest slats can be inferred from it by analogy. Besides, every slat 58 has a central hole 581. A lift cord 54 of the window blind 1 is located between the first longitudinal string L1 and the second longitudinal string L2 and inserted through the central hole 581 of every slat 58. The aforementioned adjustable bottom retainer 10 includes a base 20, a first worm rod 30, and a second worm rod 40.

The base 20 is composed of two half shells 21 coupled with each other. The top surface of every half shell 21 has an arc notch 22. The two arc notches 22 are coupled to become a lift cord inserting hole 28, as shown in FIG. 1. Every half shell 21 has a recess 24 located below the arc notch 22. The two recesses 24 are coupled to become an open trough 25 as shown in FIG. 2, which is opened downward and communicates with the lift cord inserting hole 28. Besides, every half shell 21 has two first supporting portions 26 upward and downward facing each other, and two second supporting portions 27 frontward and rearward facing each other, and the above-described two half shells 21 are provided with a first ladder cord inserting hole 23A and a second ladder cord inserting hole 23B respectively.

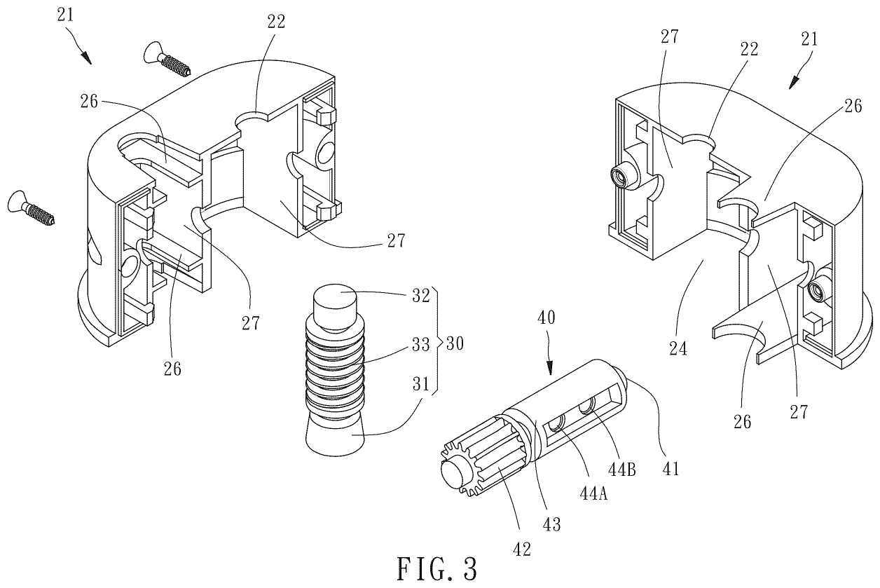

The first worm rod 30 is rotatably inserted in the base 20, and has a head portion 31, a first rod portion 32 and a first worm tooth portion 33. The head portion 31 has a cross-shaped rotation driving hole 34, as shown in FIG. 2. The bottom end of the first rod portion 32 is connected with the head portion 31. The first worm tooth portion 33 is provided on the outer circumferential surface of the first rod portion 32. As shown in FIG. 3, the first worm rod 30 is inserted into the base 20 upwardly, wherein the head portion 31 protrudes out of the bottom surface of the base 20, the top and bottom ends of the first rod portion 32 are supported by the first supporting portions 26 of the base 20.

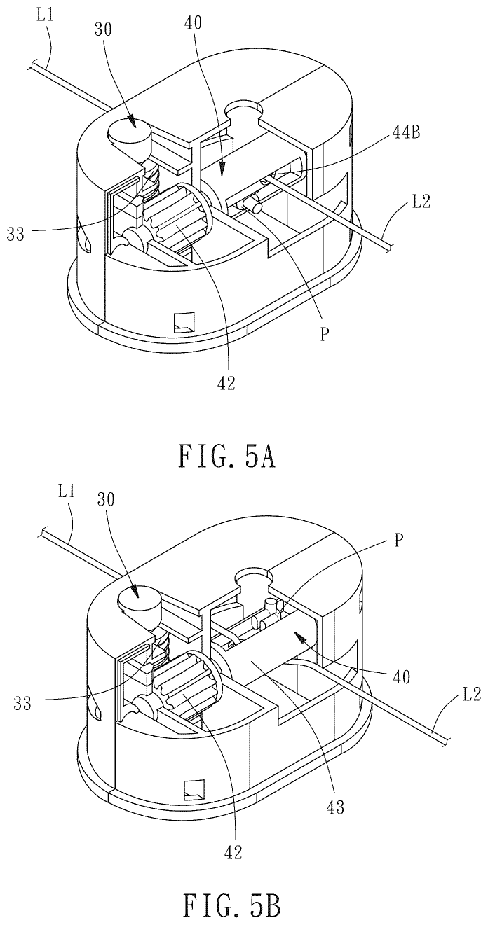

The second worm rod 40 is rotatably inserted in the base 20, and has a second rod portion 41, a second worm tooth portion 42 and a protruding annular portion 43. The second worm tooth portion 42 is provided on the outer circumferential surface of the second rod portion 41. The protruding annular portion 43 is coaxially provided on the outer circumferential surface of the second rod portion 41, and the protruding annular portion 43 and the second worm tooth portion 42 are arranged in a spaced manner. As shown in FIG. 3, the second worm rod 40 is horizontally inserted in the base 20, and the second worm tooth portion 42 is engaged with the first worm tooth portion 33 of the first worm rod 30, which means the axial direction of the second worm rod 40 is perpendicular to the axial direction of the first worm rod 30. The left and right ends of the second rod portion 41 are supported by the second supporting portions 27 of the base 20. The protruding annular portion 43 is located in the open trough 25 of the base 20. Besides, the second worm rod 40 further has a first through hole 44A and a second through hole 44B, which radially penetrate through the protruding annular portion 43 and the second rod portion 41. The first through hole 44A and the second through hole 44B both communicate with the open trough 25, and the protruding annular portion 43 of the second worm rod 40 is located in the open trough 25. The bottom end of the first longitudinal string L1 of the ladder cord C is inserted in the first through hole 44A, and the bottom end is combined with a latching member P. The latching member P is sized larger than the bore diameter of the first through hole 44A, as shown in FIG. 5A. Similarly, the bottom end of the second longitudinal string L2 of the ladder cord C is inserted in the second through hole 44B, and the bottom end is also combined with a latching member P. The latching member P is sized larger than the bore diameter of the second through hole 44B, as shown in FIG. 5B. Therefore, the bottom ends of the first longitudinal string L1 and the second longitudinal string L2 can be fastened to the second rod portion 41 through the first through hole 44A and the second through hole 44B of the protruding annular portion 43 and the two latching members P.

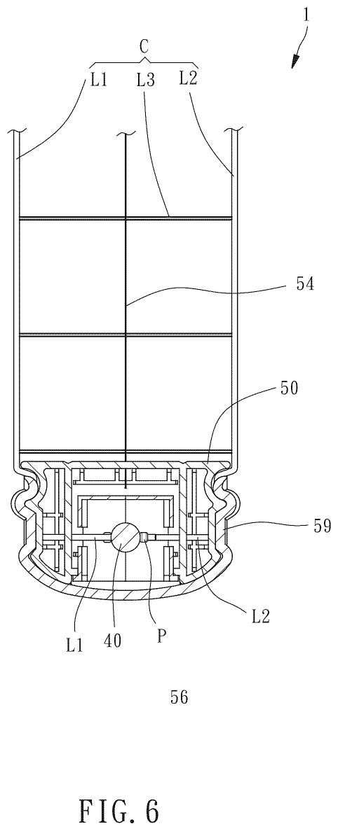

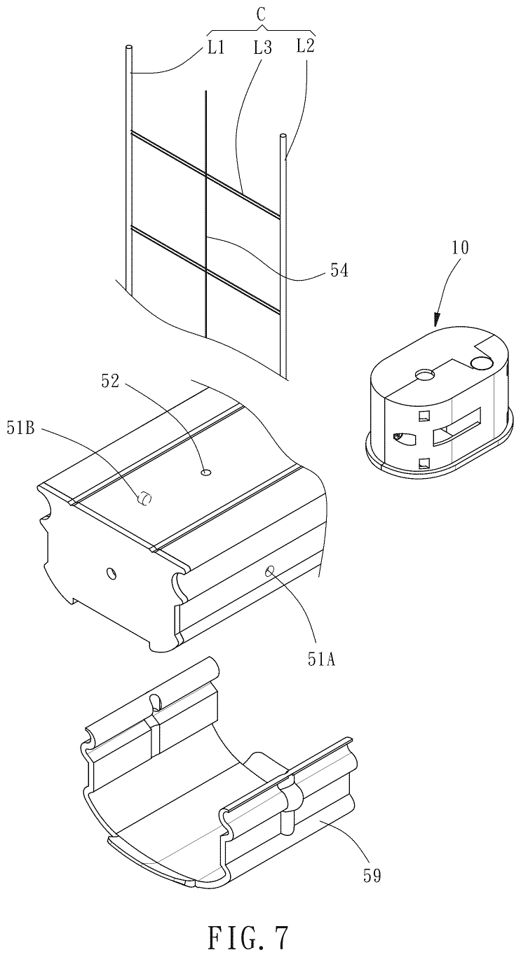

For the usage in coordination with the non-pull cord window blind 1, as shown in FIG. 4, FIG. 6 and FIG. 7 (for the convenience of showing and illustrating, only a part of the non-pull cord window blind 1 is shown in FIG. 4), the base 20 is embedded into the bottom beam 50 through the bottom surface of the bottom beam 50, and the rotation driving hole 34 of the first worm rod 30 is exposed out for the convenience of being engaged with a hand tool such as a cross screwdriver. The bottom beam 50 of the window blind 1 is provided on two opposite sides thereof with a first via 51A and a second via 51B, as shown in FIG. 7. The first via 51A and the second via 51B correspond in position to the first ladder cord inserting hole 23A and the second ladder cord inserting hole 23B of the base 20 respectively. The bottom end of the first longitudinal string L1 passes through the first via 51A and the first ladder cord inserting hole 23A in sequence, and is fastened to the first through hole 44A of the second rod portion 41 by the latching member P. The bottom end of the second longitudinal string L2 passes through the second via 52B and the second ladder cord inserting hole 23B in sequence, and is fastened to the second through hole 44B of the second rod portion 41 by the latching member P. The lift cord 54 passes through a top hole 52 of the bottom beam 50 and the lift cord inserting hole 28 of the adjustable bottom retainer 10, and the lift cord 54 is fastened to the inside of the adjustable bottom retainer 10.

When the rotation driving hole 34 of the first worm rod 30 is driven by the aforementioned hand tool to rotate, the first worm rod 30 drives the second worm rod to rotate together. During the rotation of the second worm rod 40, the bottom ends of the first longitudinal string L1 and the second longitudinal string L2 of the ladder cord C are rolled up at the same time by the protruding annular portion 43. The top end of the ladder cord C is fastened to a cord rolling device (not shown) to be kept unmoved, wherein the coordination of the ladder cord with the cord rolling device is the conventional technique and not the key point of the present invention, thereby not described hereinafter. Therefore, when the adjustment of the total length of the lift cord 54 is accomplished, the hand tool can be used to rotate the first worm rod 30, so as to roll up the bottom ends of the first longitudinal string L1 and the second longitudinal string L2 of the ladder cord C, so that the constructor can adjust the total length of the ladder cord C by the adjustable bottom retainer 10 at once. After the adjustment of the length of the ladder cord C is accomplished, a buckle member 59 of the window blind 1 can be buckled on the exterior of the bottom beam 50 to make the first longitudinal string L1 and the second longitudinal string L2 pressed between the buckle member 59 and the bottom beam 50, so that the first longitudinal string L1 and the second longitudinal string L2 of the ladder cord C can be fixed.

What is claimed is:

1. An adjustable bottom retainer for a non-pull cord window blind, which is connected with a ladder cord of the non-pull cord window blind, the ladder cord having a first longitudinal string and a second longitudinal string, which are disposed in a spaced manner, and a plurality of latitudinal strings connected between the first longitudinal string and the second longitudinal string, the adjustable bottom retainer comprising:
a base having a first ladder cord inserting hole and a second ladder cord inserting hole, which are arranged oppositely to each other;
a first worm rod rotatably inserted in the base, the first worm rod having a head portion, a first rod portion and a first worm tooth portion, the head portion having a rotation driving hole, a bottom end of the first rod portion being connected with the head portion, the first worm tooth portion being provided on an outer circumferential surface of the first rod portion; and
a second worm rod rotatably inserted in the base, an axial direction of the second worm rod being perpendicular to an axial direction of the first worm rod, the second worm rod having a second rod portion and a second worm tooth portion, bottom ends of the first longitudinal string and the second longitudinal string of the ladder cord being fastened to the second rod portion, the second worm tooth portion being provided on an outer circumferential surface of the second rod portion and engaged with the first worm tooth portion of the first worm rod.

2. The adjustable bottom retainer as claimed in claim 1, wherein the second worm rod further has a protruding annular portion; the protruding annular portion is provided on the outer circumferential surface of the second rod portion; the bottom ends of the first longitudinal string and the second longitudinal string of the ladder cord are fastened to the second rod portion through the protruding annular portion.

3. The adjustable bottom retainer as claimed in claim 2, wherein the second worm rod further has a first through hole and a second through hole, which radially penetrate through the protruding annular portion and the second rod portion; the bottom end of the first longitudinal string of the ladder cord is inserted and fastened in the first through hole; the bottom end of the second longitudinal string of the ladder cord is inserted and fastened in the second through hole.

4. The adjustable bottom retainer as claimed in claim 3, wherein the adjustable bottom retainer further comprises two latching members combined with the bottom ends of the first longitudinal string and the second longitudinal string respectively; the two latching members are sized larger than bore diameters of the first through hole and the second through hole respectively.

5. The adjustable bottom retainer as claimed in claim 4, wherein the base has an open trough opened downward and communicating with the first through hole and the second through hole; the protruding annular portion of the second worm rod is located in the open trough.

6. The adjustable bottom retainer as claimed in claim 3, wherein the base has an open trough opened downward and communicating with the first through hole and the second through hole; the protruding annular portion of the second worm rod is located in the open trough.

7. The adjustable bottom retainer as claimed in claim 1, wherein the rotation driving hole is cross-shaped.

8. The adjustable bottom retainer as claimed in claim 1, wherein a top surface of the base has a lift cord inserting hole.

9. A non-pull cord window blind comprising:
a ladder cord comprising a first longitudinal string, a second longitudinal string, and a plurality of latitudinal strings connected between the first longitudinal string and the second longitudinal string;
a bottom beam having a first via and a second via, which are arranged oppositely to each other;
an adjustable bottom retainer as claimed in claim 1, wherein the first ladder cord inserting hole and the second ladder cord inserting hole correspond to the first via and the second via respectively; the bottom end of the first longitudinal string passes through the first via and the first ladder cord inserting hole in sequence to be fastened to the second rod portion; the bottom end of the second longitudinal string passes through the second via and the second ladder cord inserting hole in sequence to be fastened to the second rod portion; and
a buckle member buckled on an exterior of the bottom beam to make the first longitudinal string and the second longitudinal string pressed between the buckle member and the bottom beam.
